(19) United States
(12) Patent Application Publication
(10) Pub. No.: US 2006/0137890 A1
(43) Pub. Date: Jun. 29, 2006

(54) Apparatus and methods for unshielded twisted wire pair radiated emission suppression

(75) Inventors: Jessica R. Berens, Rochester, MN (US); Don A. Gilliland, Rochester, MN (US); Amanda E. Mikhail, Rochester, MN (US); Dennis J. Wurth, Rochester, MN (US)

Correspondence Address: Leslie Payne;IBM Corporation, Intellectual Property Law Dept. 917, 3605 Hwy. 52 North, Rochester, MN, 55901, US

(73) Assignee: INTERNATIONAL BUSINESS MACHINES CORPORATION, ARMONK, NY (US)

(21) Appl. No.: 11/023,675

(22) Filed: Dec. 28, 2004

(51) Int. Cl. H01B 11/06

(52) U.S. Cl. 174/36

(57) ABSTRACT

In a first aspect, a first apparatus for providing radiated emission suppression in cabling is provided. The first apparatus includes (1) at least one cable; (2) one or more ferrite elements each substantially surrounding a length of the at least one cable; and (3) a capacitive sleeve element substantially surrounding a length of the at least one cable and the one or more ferrite elements. The capacitive sleeve element includes a conducting material adapted to be connected to a ground. Numerous other aspects are provided.

### FIELD OF THE INVENTION

The present invention pertains to apparatus and methods for providing radiated emission suppression and, in particular, to apparatus and methods for providing radiated emission suppression in unshielded twisted wire pairs.

### BACKGROUND OF THE INVENTION

Unshielded twisted pair (UTP) wires and cables are inexpensive and have been known to be very reliable. Conventional telephone wiring systems have, for many years, utilized UTP wires and wiring. As local area networks (LANs) and other communication networks continue to become more widely adopted and utilized, the need for inexpensive and reliable wiring and cabling for use in connection with the same has continued to grow.

UTP wires and cables have been suggested for use in LAN networks and other similar communication networks. These networks, however, operate at transmission frequencies which are typically much higher than those frequencies associated with conventional telephone networks and systems.

Higher transmission frequencies typically result in common mode currents which flow on or along the wiring, cabling, or network components. These common mode currents can result in radiated emissions which are undesirable. Radiated emissions have been found in UTP LANs, such as, for example, LANs utilized in connection with 10/100 or 1 GB Ethernet networks.

As the need for inexpensive and reliable wiring and cabling solutions for LANs and other similar communication networks continues to grow, so does the need for adequate suppression of radiated emissions, including those radiated emissions resulting from common mode currents.

### SUMMARY OF THE INVENTION

In a first aspect, a first apparatus for providing radiated emission suppression in cabling is provided. The first apparatus includes (1) at least one cable; (2) one or more ferrite elements each substantially surrounding a length of the at least one cable; and (3) a capacitive sleeve element substantially surrounding a length of the at least one cable and the one or more ferrite elements. The capacitive sleeve element includes a conducting material adapted to be connected to a ground.

In a second aspect, a second apparatus for providing radiated emission suppression in cabling is provided. The second apparatus includes (1) at least one cable; (2) a plurality of ferrite elements each substantially surrounding a length of the at least one cable; and (3) a capacitive sleeve element substantially surrounding a length of the at least one cable and the plurality of ferrite elements. The capacitive sleeve element includes a conducting material adapted to be connected to a ground. Each ferrite element of the plurality of ferrite elements creates an effective inductance and AC resistance, and each portion of the length of the at least one cable substantially surrounded by or encapsulated by the capacitive sleeve element creates an effective capacitance connected to ground. A common mode current is reduced by the effective inductance and AC resistance, and by the effective capacitance connected to ground. Therefore, radiated emissions are suppressed. Numerous other aspects are provided.

Other features and aspects of the present invention will become more fully apparent from the following detailed description, the appended claims and the accompanying drawings.

### BRIEF DESCRIPTION OF THE DRAWINGS

FIG. 1 illustrates an exemplary embodiment of the apparatus of the present invention;

FIG. 2 illustrates an exemplary ferrite element which can be utilized in connection with the present invention;

FIG. 3 illustrates another exemplary ferrite element which can be utilized in connection with the present invention;

FIG. 4 illustrates an exemplary capacitive shield element which can be utilized in connection with the present invention that increases capacitance and provides electric field shielding between wire pairs;

FIG. 5 illustrates an “effective” circuit of the apparatus of FIG. 1 showing each of the “effective” circuit elements therein;

FIG. 6 illustrates a low frequency circuit equivalent of the circuit of FIG. 5;

FIG. 7 illustrates another exemplary embodiment of a ferrite element provided in accordance with the present invention; and

FIG. 8 illustrates another exemplary embodiment of the apparatus of the present invention that employs the ferrite element of FIG. 7.

### DETAILED DESCRIPTION

The present invention pertains to apparatus and methods for suppressing radiated emissions from unshielded twisted pair (UTP) wires or other cabling. The present invention provides for the suppression of radiated emissions from UTP wires or other cabling by employing ferrite elements and a capacitive sleeve element in the manner described herein. In one exemplary embodiment, the present invention combines the use of ferrite elements, ferrite materials, and/or ferrite cores (collectively referred to as “ferrite elements”), along with a capacitive sleeve element, which can be placed over the UTP wires or other cabling as well as over the ferrite elements. The capacitive sleeve element can be connected to, or referenced to, ground such as a chassis ground or a ground associated with a LAN or other connector.

The present invention can combine the respective ferrite elements along with a capacitive sleeve or capacitive sleeve element in order to form a series inductance/alternating current resistance along with a capacitance connected to, or referenced to, ground. The capacitive sleeve element can exhibit two responses which serve to aid in suppressing any emissions which can radiate from the UTP wires or other cabling. A first response can form a ¼ wavelength antenna which can exhibit a narrowband response based upon the length and capacitance of the capacitive sleeve and its connection to ground.

A second response can form a wideband capacitive coupling which can serve to lower any common mode impedance of the UTP wiring or other cabling on the load side of the respective ferrite element.

A respective ferrite element can also be used to mismatch its input and output impedances as it is a magnetic device or element which operates to provide a high impedance and minimum current associated with any offending signal or signals. The offending signal or signals can be, for example, a high frequency signal, high frequency signals, and/or harmonics of the same.

A low impedance is formed at a down current, capacitance side of the respective ferrite element thereby providing for an enhanced wideband response.

In an exemplary embodiment, a plurality of respective ferrite elements or other absorptive elements and a capacitive sleeve element can be provided along LAN UTP wiring or other cabling so as to form a mechanical L filter with a series inductance and a shunt capacitance. The embodiment can also be fashioned to produce a pi filter, or a T or ladder network filtering arrangement, which serves to widen and further attenuate any common mode signals which can occur or become present in a LAN UTP or other environment.

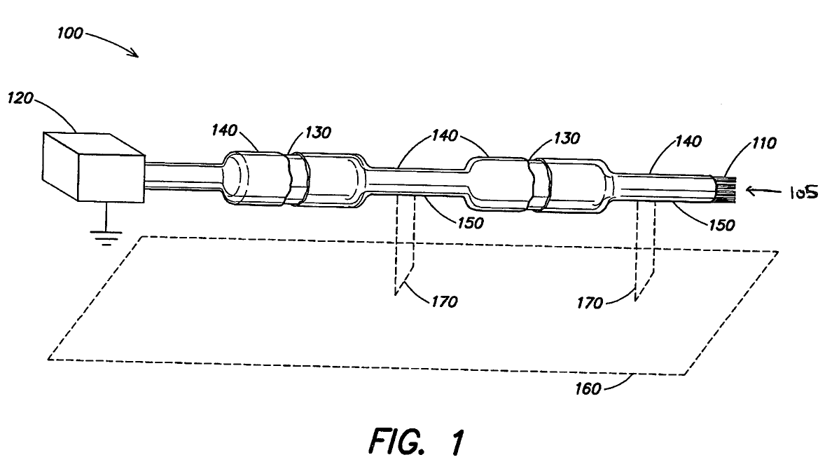

FIG. 1 illustrates an exemplary embodiment of apparatus of the present invention which is designated generally by the reference number 100. With reference to FIG. 1, the apparatus 100 includes a cable system 105 that includes one or more wire pairs or other cables which, in the exemplary embodiment of FIG. 1, are unshielded twisted pairs (UTPs) 110 which can be used in a local area network (LAN), an Ethernet network, and/or in any other communication network. The unshielded portion of the wire pairs 110 can be seen at the far right of the apparatus 100 in FIG. 1.

Note that any number of wires and/or cables, including a single wire or cable, can be employed. The present invention can also be used in connection with power supply and/or power supply system cabling. For example, a power supply cable may include a plurality untwisted wire pairs, and the present invention may be employed to provide radiation suppression in such a cable.

With reference once again to FIG. 1, the apparatus 100 also includes a LAN connector 120 which is connected to, or referenced to, ground, or any other suitable connector depending upon the use or application of the apparatus 100. The LAN connector 120 can be attached to a terminal portion of the wire pairs 110 (as shown) in any appropriate manner. In an exemplary embodiment, the LAN connector 120 can be shielded so as to suppress radiated emissions at the end portion or region of the wire pairs 110. For example, the LAN connector 120 can be of a shielded twisted pair (STP) type or variety and can provide a ground connection, or reference to ground. Other types of connectors may be used.

The apparatus 100 also includes one or more of ferrite elements 130 which are provided along the length of, and substantially surround or encapsulate, the wire pairs 110 at spaced intervals, as shown. In an exemplary embodiment, the ferrite elements 130 can be selected depending upon the operating frequency or frequencies of the common mode electrical signals which are expected to be conducted by the wire pairs 110. For example, in an Ethernet LAN network embodiment having an operating frequency harmonic of 525 MHz, a No. 25 ferrite material available from Steward, Inc. of Chattanooga, Tenn. can provide a desired permeability at 525 MHz. Any suitable ferrite material or ferrite materials can be selected and utilized depending upon each particular application. Non-Ethernet related frequencies also can be suppressed.

In another exemplary embodiment, multiple ferrite materials can be used to address different electrical properties which may be present along any given wire pairs 110. For example, a first type of ferrite material (e.g., a Steward, Inc., No. 25 sintered ferrite material) may be used in a vicinity close to the LAN connector 120, in order to suppress radiated emissions at higher frequencies, while a second type of ferrite material (e.g., a Steward, Inc., No. 28 sintered ferrite material) may be used along the wire pairs 110 at a location which is further away from the LAN connector 120 so as to suppress any radiated emissions at any lower frequencies present at that location along the wire pairs or cables. In another embodiment, a Fair-rite Products Corporation, No. 61 ferrite material may be positioned closest to the connector 120 for high frequency suppression and a Fair-rite Products Corporation, No. 43 ferrite material may be positioned farther from the connector 120 for lower frequency suppression.

Each ferrite element 130 preferably is spaced from the connector 120 by a distance of about one quarter of a wavelength of the frequency to be suppressed by the ferrite element 130. Accordingly, a ferrite element 130 that is to suppress a low frequency (e.g., a long wavelength) will be spaced a greater distance from the connector 120 than a ferrite element 130 that is to suppress a high frequency (e.g., a short wavelength). More that two ferrite elements may be used.

In general, any suitable type of ferrite material or materials, having any suitable permeability, can be selected and used for any given application and/or for any operating frequency or frequencies and/or for any harmonics of the same. It is important to note that while the present invention may be described as being utilize in connection with specified operating frequencies, the present invention is not limited to any particular frequencies or ranges of frequencies. Ferrite elements or other absorptive elements selected for use in the present invention can be selected based upon known permeability versus frequency curves and the frequencies or ranges associated with the particular application. The respective lengths, widths, thicknesses, etc., of the respective ferrite elements or other absorptive elements can be selected for the particular application and/or any physical constraints of the associated application.

In one exemplary embodiment, when the apparatus 100 includes four wire pairs, the ferrite elements 130 can be in the form of cylindrically shaped ferrite beads having a length of about 1½ inches, a diameter of about ½ inch, and a bore or hole therethrough, for receiving the wire pairs 110, which has a diameter of about 3/16 inch. A ferrite element spacing (from the connector 120) of about a quarter of a wavelength of the frequency to be suppressed may be employed. Other ferrite element sizes and/or spacings may be used.

With reference once again to FIG. 1, the apparatus 100 also includes a capacitive sleeve element 140 which can be placed on, around, or about, the wire pairs 110 and the ferrite elements 130, along a desired length of the wire pairs 110, so as to substantially surround or encapsulate the same. In the embodiment shown, the capacitive sleeve element 140 substantially surrounds or encapsulates the portions of the wire pairs 110 in the regions 150 between the ferrite elements 130, as well as the ferrite elements 130 located along the length of the wire pairs 110.

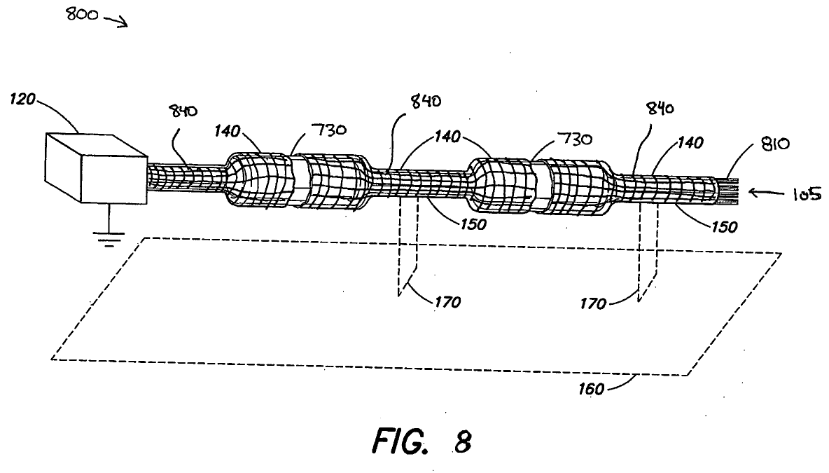

The capacitive sleeve element 140 contains electrical conducting material or a conduction element(s) placed in contact with, or connected to, the ground or ground contact of the LAN connector 120 so as to effectuate the grounding of the capacitive sleeve element 140. The capacitive sleeve element 140 can be, for example, any suitable heat shrinkable tubing material having an electrical conducting element(s) therein. (Alternatively, the capacitive sleeve 140 may comprise another conducting material such as a braided shield as described below with reference to FIG. 8.) In an exemplary embodiment, the heat shrinkable tubing material substantially surrounds and encases the conducting element(s) and/or can include a silver conducting material, an aluminized polyester film such as Mylar® available from Dupont, a spiral wrap material, and/or any other suitable material or materials consistent with the present invention. The capacitive sleeve element 140 may, but need not, be insulated or contain insulation. Exemplary heat shrinkable tubing is available from Methode Development Co. of Chicago, Ill. under the product name Methode EMC shrinkMate Connector. Other heat shrink tubing types may be used.

Once installed over and along the desired length of the wire pairs 110 and the ferrite elements 130, the capacitive sleeve 140 can be heat shrunk around, and/or otherwise attached to, or formed onto, the same. Non-heat shrinkable capacitive sleeve elements also may be used.

Each ferrite element 130 and the capacitive sleeve element 140 can be selected or designed so as to substantially surround and encapsulate any number of wire pairs 110.

In at least one embodiment of the invention, the capacitance sleeve 140 can be attached to a chassis 160 (shown in phantom) and/or to a ground reference using a conductive material 170 (shown in phantom). The conductive material 170 may be, for example, one or more conductive clamps. Such clamps can be formed from metal, a conductive polymer, or the like and can be attached to the chassis using a conductive adhesive material or by any other suitable mechanism.

In another exemplary embodiment, the conductive material 170 may include conductive ribbon having an adhesive tape or a conductive tape. In still another exemplary embodiment, the conductive material 170 may include a conductive foam and the wire pairs 110 can be inserted, at specific locations and/or along the length of the same, into a piece or pieces of the conductive foam which can be adhered to the chassis wall 160. In this embodiment, wherein conductive foam is utilized, the foam's profile can be easily modified to conform with existing or allowable space(s). Further, a simple slit made or formed along the length of the foam can be utilized for retaining the wire pairs 110.

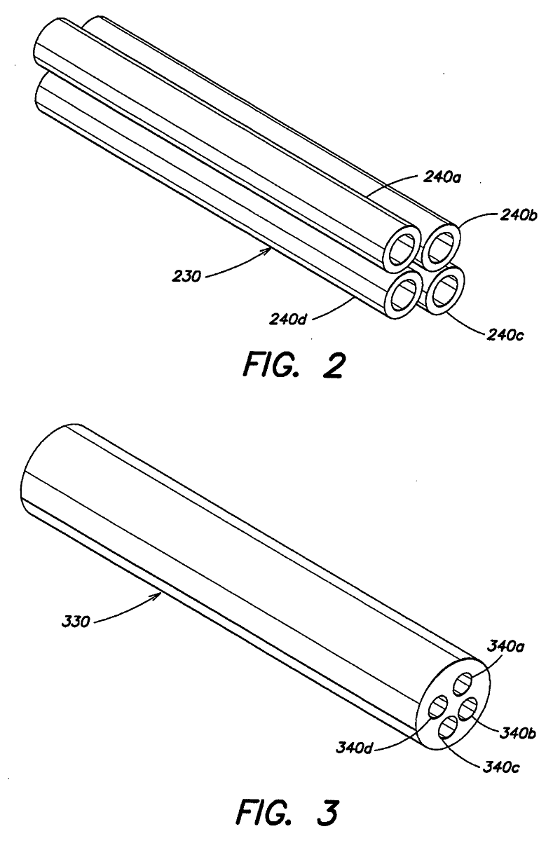

FIG. 2 illustrates another exemplary ferrite element which can be utilized in connection with the present invention and which is designated by the reference numeral 230. In FIG. 2, the ferrite element 230 can be designed, as shown, so as to include a plurality of cylindrical ferrite housings 240a-d, with each ferrite housing 240a-d being adapted to receive a wire pair or group of wire pairs (or other wire types). In effect, the ferrite element 230 of FIG. 2 serves as four separate ferrite elements all of which are formed together in the single ferrite element 230. Although shown as having four separate ferrite housings having bores or holes for receiving a wire pair or group of wire pairs, the ferrite element 230 can be designed to have any number of separate ferrite housings. The dimensions, material type or other characteristics of the ferrite element 230 may be selected based upon the type of common mode suppression desired.

FIG. 3 illustrates another exemplary embodiment for a ferrite element which is designated by the reference numeral 330. In FIG. 3, the ferrite element 330 can be formed of a single cylindrical ferrite element which has a plurality of bores or holes 340a-d therein, as shown, each for receiving a wire pair or a group of wire pairs (or other wire types).

In another exemplary embodiment, the ferrite element 330 can be of any appropriate cross sectional shape (e.g., square, rectangular, oval, circular, etc.) and can have any number of bores or holes, for receiving any number of wire pairs or groups of same therein. Any of the ferrite elements 130, 230 and 330, described herein, can have any appropriate permeability, size, length, or thickness.

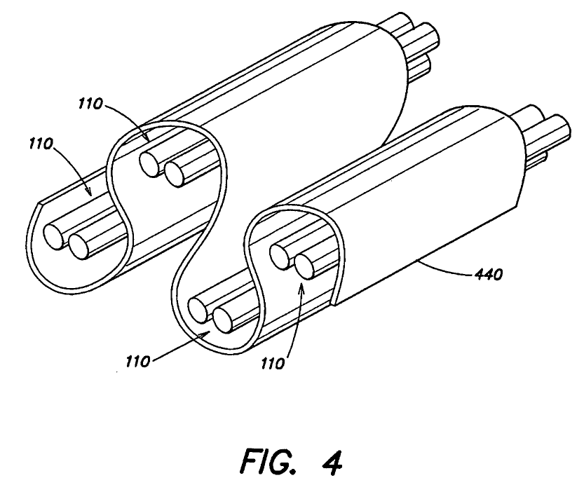

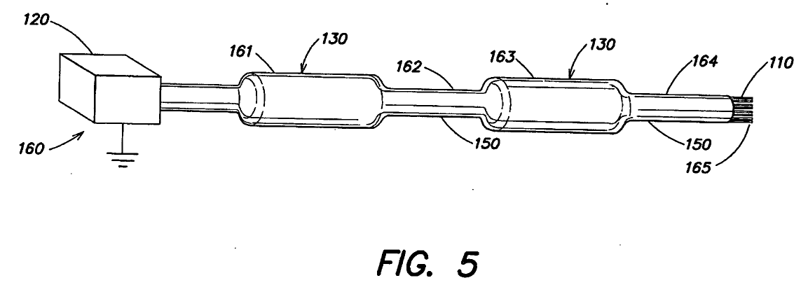

FIG. 4 illustrates an exemplary embodiment of a capacitive shield element which is designated by the reference numeral 440. The capacitive shield element 440 can be designed or adapted as shown so as to substantially surround and encapsulate any number of wire pairs 110. The capacitive shield element 440 can be interspersed between and around any number of wire pairs or cables or groups of the same, as shown, and thereafter can be sealed in any appropriate manner. By being interspersed between and around a plurality of wire pairs or groups of wire pairs, the capacitive shield element 440 may provide for an increased capacitance. The capacitive shield element 440 may be formed of any of the materials described herein, or from any other suitable material.

FIG. 5 illustrates the “effective” circuit of the apparatus 100 of FIG. 1 showing each of the “effective” circuit elements therein designated by respective reference numerals.

With reference to FIG. 5, from left to right, the LAN connector 120 serves to create an “effective” circuit ground which is designated by the reference numeral 160, the first ferrite element 130 creates a first “effective” inductor or inductance which is designated by the reference numeral 161, and the first region 150 where the capacitive sleeve element 140 encapsulates the wire pairs 110 from left to right creates a first “effective” capacitor or capacitance which is designated by the reference numeral 162. Since the conducting material of the capacitive sleeve element 140 is connected to the ground of the LAN connector 120, the “effective” capacitor or capacitance, created by the region 150 where the capacitive sleeve element 140 substantially surrounds or encapsulates the wire pairs 110, creates an “effective” capacitor or capacitance connected to, or referenced to, ground.

With reference once again to FIG. 5, the second ferrite element 130 creates a second “effective” inductor or inductance which is designated by the reference numeral 163, and the second region 150 where the capacitive sleeve element 140 encapsulates the wire pairs 110 creates a second “effective” capacitor or capacitance which is designated by the reference numeral 164. Since the conducting material of the capacitive sleeve element 140 is connected to ground, the second “effective” capacitor or capacitance 164 is also connected to, or referenced to, ground. The exposed wire pairs 110 are a conductor which is designated by the reference numeral 165.

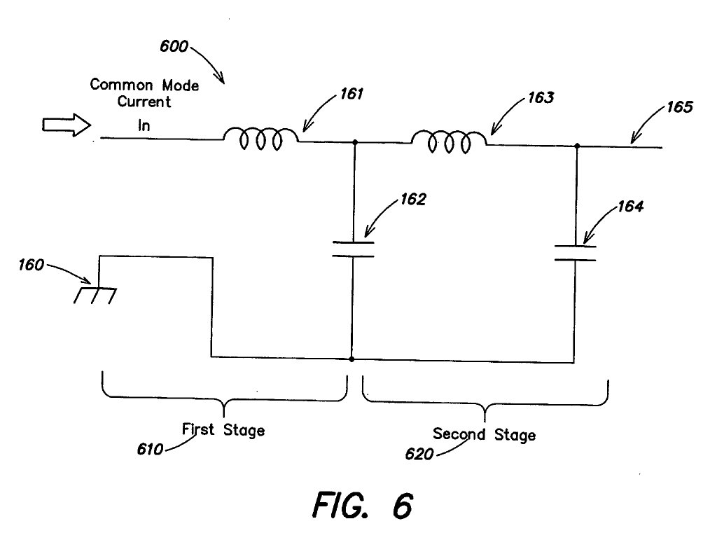

FIG. 6 illustrates the electrical equivalent circuit 600 of the apparatus 100 of FIG. 5 showing the “effective” circuit elements of the same. The equivalent circuit shown in FIG. 6 is a pi circuit or pi filter. As shown in FIG. 6, the equivalent circuit includes the LAN connector 120 which is represented by circuit ground 160. The equivalent circuit also includes the first “effective” inductor or inductance 161, which is created by the first ferrite element 130 and which is connected in series with the input current, which input current, in the exemplary embodiment, is the common mode current. The first “effective” capacitor or capacitance 162 is connected in shunt with the first inductor or inductance 161 and is connected or tied to circuit ground 160. In an exemplary embodiment, the first “effective” inductor or inductance 161 and the first “effective” capacitor or capacitance 162 form a “first stage” 610 of the pi circuit or pi filter 600 illustrated in FIG. 6.

With reference once again to FIG. 6, the second “effective” inductor or inductance 163, which is created by the second ferrite element 130, is connected in series with the output of the inductor or inductance 161/capacitor or capacitance 162 “first stage” 610. The second “effective” capacitor or capacitance 164 is connected in shunt with the second inductor or inductance 163 and is connected to or tied to circuit ground 160. In an exemplary embodiment, the “effective” inductor or inductance 163 and the “effective” capacitor or capacitance 164 form a “second stage” 620 of the pi circuit or pi filter 600 illustrated in FIG. 6.

Additional inductor/capacitor stages can also be provided, as deemed appropriate or necessary, by adding additional ferrite elements 130 and corresponding regions 150 where the capacitive sleeve element 140 substantially surrounds or encapsulates sections or regions of the wire pairs 110. Multiple capacitive sleeve elements may be used. As stated, in at least one embodiment, each ferrite element is spaced from the connector 120 by a distance of approximately one quarter of a wavelength of the frequency to be suppressed by the ferrite element.

In an exemplary embodiment, the apparatus 100 of the present invention can be utilized to perform LAN UTP or other cabling radiated emission suppression in the following manner. Upon the introduction of current or power to the apparatus 100, the first “effective” inductor or inductance 161 of the first ferrite element 130 serves to increase the impedance of the circuit and thereby reduces the amount of current which flows in the circuit. This impedance can be referred to as the “high common mode impedance” which typically has a high value as a result of the ferrite 130 and the resulting “effective” inductor or inductance 161. This above-described reduction in current results in reduced radiated emissions from the wire pair or cables 110.

The apparatus 100 then provides for the mismatching of the high common mode impedance which is present after the first ferrite element 130 (“effective” inductor or inductance 161), with the “effective” capacitor or capacitance 162 which is created by the first region 150 where the capacitive sleeve 140 encapsulates the wire pairs 110. The “effective” capacitor or capacitance 162 serves to present a lower circuit impedance and a capacitance to ground which serves to reduce common mode current in the circuit and decreases the radiating loop area.

In this manner, the “effective” inductor or inductance 161 of the first ferrite element 130 increases circuit impedance thereby reducing circuit common mode current and the “effective” capacitor or capacitance 162 created by the first region 150 decreases the circuit impedance and drives or brings the common mode current to ground. The described reduction of current and subsequent grounding of the current which flows in the wire pairs 110, by the “first stage” of the circuit, serves to lower the common mode current and to suppress radiated emissions which could result from the propagation of the common mode current on or along the length of the wire pairs 110 or any network components.

The second “effective” inductor and inductance 163, which is created by the second ferrite element 130, and the second “effective” capacitor or capacitance 164, which is created by the second region 150 where the capacitive sleeve element 140 substantially surrounds or encapsulates the wire pairs 110, serves to further reduce the common mode current flowing in the circuit 600, first by increasing the circuit impedance and, in turn, reducing the current and, thereafter, by decreasing the circuit impedance with the “effective” capacitor or capacitance 164 and by driving or bringing the common mode current to ground. This additional step of reducing the common mode current and driving or bringing the reduced current to ground, by this “second stage” of the circuit, serves to further lower the common mode current and to suppress radiated emissions which could result from the propagation of the same on or along the length of the wire pairs 110 or any network components. Suppression of radiation emissions in other cables, such as power supply cables, may be similarly achieved via the present invention.

The present invention thus provides apparatus and methods for reducing common mode currents and for driving or bringing these reduced currents to ground. The reduction in common mode currents in a LAN or other circuit reduces the propagation of these common mode currents on or along the length of the wire pairs 110 and/or on or along any network components. The reduction in common mode currents serves to suppress radiated emissions which are known to result from the existence and propagation of common mode currents on or along a length of a wire pair(s) or cable(s) or on or along any network components.

In the above-described manner, the ferrite elements 130 and the capacitive sleeve element 140 serve to reduce common mode current(s) in unshielded wire pairs or cables, and in LAN networks and/or systems and/or in other networks and/or systems which utilize unshielded twisted wire pairs or cables, and thereby serve to suppress radiated emissions known to result from such common mode current(s). The apparatus and methods of the present invention can also find application in any other networks or systems where common mode currents may be known to occur (e.g., power supply cables, triax cables, etc.).

In another exemplary embodiment, the ferrite elements 130 can be selected to suppress radiated emissions in unshielded twisted wire pairs or other cables for any given frequency, frequencies, or harmonic frequencies of the same. For example, and as noted before, the ferrite elements 130, in an exemplary embodiment can be selected for suppressing radiated emissions resulting from a frequency of about 525 MHz, which frequency is a common harmonic frequency encountered in Ethernet LANS, and/or for suppressing radiated emissions resulting from any other high frequency network.

The ferrite elements can be selected to provide a certain “effective” inductor, inductance and/or AC resistance while the capacitive sleeve element can be selected to create a certain “effective” capacitor and/or capacitance, for any given frequency or frequencies so that radiated emissions can be suppressed for any given frequency or frequencies. In this regard, any appropriate ferrite materials and any appropriate capacitive sleeve materials and/or capacitive sleeve conducting materials can be selected, depending upon the frequency or frequencies which are expected to be encountered and for which radiated emission suppression is desired. Any number of ferrite elements and/or capacitive sleeve elements may be used.

In another exemplary embodiment, the capacitive sleeve 240 shown in FIG. 4, can be utilized to increase the value of the effective capacitor or capacitance created thereby so as to reduce the impedance in that respective portion of the circuit and to provide for an enhanced grounding of the circuit current.

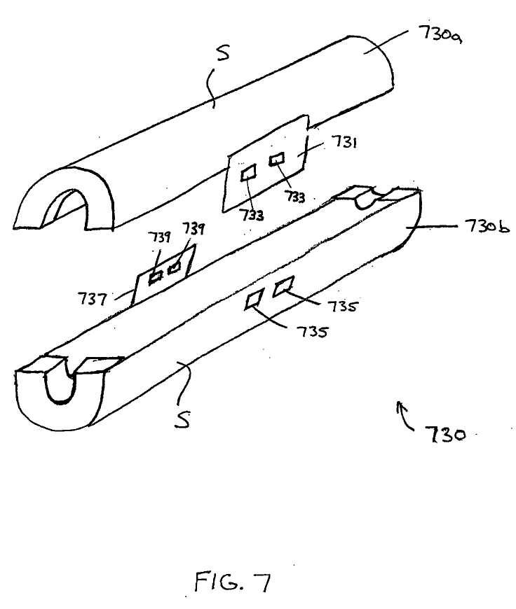

FIG. 7 illustrates another exemplary embodiment of a ferrite element 730 provided in accordance with the present invention. As shown in FIG. 7, a ferrite element 730 includes a first ferrite portion 730a and a second ferrite portion 730b. Each ferrite portion 730a, 730b preferably includes an outer surface S that is conductive. For example, the outer surface of each ferrite portion 730a, 730b may include a metal conductor, be metal plated, be painted with a metal paint, or the like.

In the exemplary embodiment of FIG. 7, the first ferrite portion 730a has attached thereto or formed therein a flange 731 containing connecting features (e.g., openings) 733. The second ferrite portion 730b includes connecting elements 735 which are adapted to mate with the connection features 733 of the flange 731. When the connecting features 733 are mated with the connecting elements 735, the flange 731 provides an overlap of or otherwise couples the first ferrite portion 730a with the second ferrite portion 730b.

In the embodiment of FIG. 7, the second ferrite portion 730b can also have attached thereto or connected therewith a flange 737 which has connecting features (e.g., openings) 739 which are adapted to mate with or connect with corresponding connecting elements (not shown) included on the first ferrite portion 730a. When the connecting features 739 are mated with the connecting elements of the first ferrite portion 730a, the flange 737 provides an overlap of or otherwise couples the second ferrite portion 730b with the first ferrite portion 730a.

The flanges 731 and 737, in an exemplary embodiment, can be manufactured from a metal conductor, a metal plated element, a painted metal element, a plastic material painted with a metallic paint or any other suitable material.

FIG. 8 illustrates another exemplary embodiment of the apparatus of the present invention which is designated generally be the reference numeral 800 and that employs the ferrite elements 730 of FIG. 7. In FIG. 8, the ferrite elements 730 are provided at spaced intervals along the wire pairs 810 as shown. For example, each ferrite element 730 may be spaced from the connector 120 by a distance of approximately one quarter of a wavelength of the frequency to be suppressed by the ferrite element. A braided metal or other conducting shield 840 is placed on or substantially around each ferrite element 730 as shown (e.g., in place of the above described heat shrinkable tubing) so as to form the capacitive sleeve element 140. The braided shield 840 may be formed from any suitable conducting material such as nickel-plated copper or the like, and may be, for example, permanently attached and/or grounded in any suitable manner. Preferably the braided shield 840 is coupled so as to tightly conform to the ferrite elements 730 and the cable/wire pairs 810 (e.g., to maximize capacitance). Note that the apparatus 800 operates similar to the apparatus 100 of FIG. 1, but in some cases may be easier to implement.

While the present invention has been described and illustrated in a number of exemplary embodiments, such are merely illustrative of the present invention and are not to be construed to be limitations thereof. Accordingly, the present invention includes all modifications, variations and/or alternate embodiments with the scope of the present invention being limited only by the claims which follow.

1. An apparatus for providing radiated emission suppression in one or more cables, comprising:
at least one cable;
one or more ferrite elements, wherein each ferrite element substantially surrounds a length of the at least one cable;
a capacitive sleeve element, wherein the capacitive sleeve element substantially surrounds a length of the at least one cable and the one or more ferrite elements, wherein the capacitive sleeve element further comprises a conducting material adapted to be connected to a ground; and
wherein at least one of the one or more ferrite elements is spaced apart from a connector of the at least one cable by a distance of approximately one quarter of a wavelength of a frequency to be suppressed by the ferrite element.

2. The apparatus of claim 1 wherein the at least one cable comprises at least one unshielded twisted pair of wires.

3. The apparatus of claim 1 wherein the at least one cable comprises a power supply cable.

4. The apparatus of claim 1 further comprising a plurality of the ferrite elements spaced along the at least one cable.

5. The apparatus of claim 1, further comprising:
a connector electrically connected with a terminal end portion of the at least one cable.

6. The apparatus of claim 5, wherein the connector is a shielded connector.

7. The apparatus of claim 5, wherein the connector is adapted to connect to a circuit ground or a chassis ground.

8. The apparatus of claim 1, wherein at least one ferrite element comprises a sintered ferrite material.

9. The apparatus of claim 1, wherein at least one ferrite element has a cylindrical shape.

10. The apparatus of claim 1, wherein the conducting material of the capacitive sleeve element is connected to a ground connection of a connector located at a terminal end portion of the at least one cable.

11. The apparatus of claim 1, wherein the capacitive sleeve element, further comprises:
a heat shrinkable tubing material, wherein the conducting material is located within the heat shrinkable tubing material.

12. The apparatus of claim 1, wherein the capacitive sleeve element, comprises a braided shield.

13. The apparatus of claim 1, wherein at least one ferrite element is formed from a single piece of ferrite material and includes a plurality of holes each adapted to surround one or more cables.

14. The apparatus of claim 1, wherein the capacitive sleeve element is adapted to surround or encapsulate a plurality of wire pairs or groups of wire pairs.

15. An apparatus for providing radiated emission suppression in one or more cables, comprising:
at least one cable;
a plurality of ferrite elements, wherein each ferrite element substantially surrounds a length of the at least one cable; and
a capacitive sleeve element, wherein the capacitive sleeve element substantially surrounds a length of the at least one cable and the plurality of ferrite elements, wherein the capacitive sleeve element further comprises a conducting material adapted to be connected to a ground;
wherein at least one of the plurality of ferrite elements is spaced apart from a connector of the at least one cable by a distance of approximately one quarter of a wavelength of a frequency to be suppressed by the ferrite element; and
wherein each ferrite element of the plurality of ferrite elements creates an effective inductance, and further wherein each portion of the length of the at least one cable substantially surrounded by or encapsulated by the capacitive sleeve element creates an effective capacitance connected to ground, wherein a common mode current is reduced by the effective inductance and by the effective capacitance connected to ground, and further wherein radiated emissions are suppressed.

16. The apparatus of claim 15 wherein the at least one cable comprises at least one unshielded twisted pair of wires.

17. The apparatus of claim 15 wherein the at least one cable comprises a power supply cable.

18-23. (canceled)
